(19) United States
(12) Patent Application Publication
(10) Pub. No.: US 2004/0162756 A1
(43) Pub. Date: Aug. 19, 2004

(54) Content generation optimizer

(76) Inventor: Blagojce Sekulovski, Ravenna, OH (US)

Correspondence Address: John M. Skeriotis, Brouse McDowell, LPA, 500 First National Tower, 106 S. Main Street, Akron, OH, 44308-1471, US

(21) Appl. No.: 10/722,741

(22) Filed: Nov. 25, 2003

Related U.S. Application Data
(63) Continuation-in-part of application No. 10/325,987, filed on Dec. 20, 2002.
(60) Provisional application No. 60/343,108, filed on Dec. 21, 2001.

(51) Int. Cl. G06F 17/60

(52) U.S. Cl. 705/14

(57) ABSTRACT

An Internet computer-searching means is included that displays two screen sections: a search section and a results display section. Software optimally arranges and rearranges associated E-commerce entities' advertisements on discrete display pages that are displayed in the results display responsive to search criteria entered in the search section.

### CONTENT GENERATION OPTIMIZER

This patent application claims priority to U.S. Utility patent application Ser. No.: 10/325,987 filed on 20 Dec. 2002, which claims priority to U.S. Provisional patent application Ser. No.: 60/343,108.

### BACKGROUND OF THE INVENTION

A. Field of Invention

This invention pertains to the art of methods and apparatuses for electronically displaying advertising data onto discrete electronic display pages, and more specifically to optimally organizing advertising on the discrete electronic display pages.

B. Description of the Related Art

It is known in the art to provide phone book yellow pages for use in advertising business goods and services. With the advent of personal computers and the wide spread use of the Internet, consumers have turned to Internet search engines in hope of obtaining vendor information. Coincidently, companies and individuals have turned to the Internet to conduct E-commerce, which allows them to take advantage of the widespread exposure to many additional potential customers. Advertising on the Internet has therefore has become an important aspect of E-business or business conducted over the Internet.

Search engines are one common way that computer users seek out advertising information over the Internet. However, search engines typically select websites based on the words of the search criteria as found on the actual web page. Typically a myriad of websites are listed that do not relate to business advertisements or contact listings. For example, technical websites containing the search criteria words are frequently displayed as a result from a typical search with a search engine. These type of websites provide help to those seeking technical information but do not provide assistant to users interested in obtaining company contact information. What is needed is an electronic means of searching for E-commerce businesses within a geographic region that can be formatted to present business advertising and listing data in electronic discrete pages wherein the data is optimally configured for display on the electronic pages.

### SUMMARY OF THE INVENTION

According to one aspect of the present invention, a method of displaying advertising data for E-commerce entities includes providing advertising information for a plurality of advertising entities, the advertising information comprising one or more advertisements, providing a microprocessor-based logic processor for use in electronically storing the advertising information, arranging at least a first discrete electronic display page of at least a first portion of the advertising information in a multi-columnar format, providing an electronic searching means operatively communicated to access the advertising information for use in selectively identifying at least one advertisement, selectively searching for at least one advertisement, and displaying the at least a first discrete electronic display page containing the selectively searched at least one advertisement.

Another aspect of the subject invention includes providing an electronic displaying means for use in displaying electronic data, the electronic displaying means being operatively communicated to the microprocessor-based logic processor, and displaying at least a first discrete electronic display page containing the selectively searched at least one advertisement on the electronic displaying means.

Yet another aspect of the subject invention includes electronically receiving the selectively identified discrete electronic display page containing at least one of the plurality of individual advertisements.

Still another aspect of the subject invention includes providing an electronic searching means communicated through an associated computer network to access the advertising information for use in selectively identifying at least one advertisement.

Yet another aspect of the subject invention includes providing advertising information for a plurality of advertising entities, the advertising information comprising one or more advertisements, the advertisements including listing ads and banner ads, wherein the banner ads correspond to the listing ads.

Still another aspect of the subject invention includes providing a computer server operatively connected to the Internet for use in electronically storing the advertising information.

Yet another aspect of the subject invention includes arranging at least a first discrete electronic display page of at least a first portion of the advertising information in a multi-columnar format, wherein the corresponding banner ads are positioned proximate to the listing ads.

Still yet another aspect of the subject invention includes providing an interactive electronic display screen having a first search section and a second display section, providing one or more associated E-commerce entities having at least one of advertising data and listing data, storing the advertising data and listing data, prearranging segments of the advertising data and listing data onto individual electronic display pages, providing a communication link between the interactive electronic display screen and the advertising data and listing data, selectively searching for a specific item of advertising data or listing data in the first search section, retrieving the electronic display page having said specific item of data, and displaying the electronic display page in the second display section.

Yet another aspect of the subject invention includes providing a microprocessor based interactive electronic display screen having a first search section and a second display section.

Still another aspect of the subject invention includes providing a micro-computer having a display screen exhibiting a first search section and a second display section.

Yet another aspect of the subject invention includes providing a portable microprocessor based interactive electronic display screen having a first search section and a second display section.

Still another aspect of the subject invention includes providing one or more E-commerce entities having associated advertising data and associated listing data respectively, wherein the display size of the associated advertising data and associated listing data varies from one E-commerce entity to the next.

Yet another aspect of the subject invention includes statically prearranging segments of the advertising data and listing data onto individual electronic display pages, wherein the advertising data and listing data is optimally arranged into multiple columns.

Still another aspect of the subject invention includes electronically sorting the advertising data and listing data into a plurality of end-categories beginning in the upper left hand corner and leftward column and proceeding alphabetically down each column from left to right ending in the bottom right corner of the right-most column.

Yet another aspect of the subject invention includes electronically sorting the advertising data and listing data alphabetically under appropriate end-categories in each individual column.

Even yet another aspect of the subject invention includes providing a first group of one or more advertisements for a first group of associated E-commerce entities, the advertisements comprising: advertising data and listing data, electronically storing the first group of advertisements on a computer server, prearranging segments of the first group of one or more advertisements onto discrete electronic display pages, providing an interactive searching means for use in searching one or both of advertising data and listing data, the interactive searching means being operatively communicated to the computer server, adding advertisements to the first group of one or more advertisements thereby comprising a second group of advertisements, and, rearranging segments of the second group of advertisements onto discrete electronic display pages.

Yet another aspect of the subject invention includes prearranging segments of the first group of one or more advertisements onto discrete electronic display pages, wherein the advertising data is located proximate to the listing data.

Yet another aspect of the subject invention includes rearranging segments of the second group of advertisements onto discrete electronic display pages, wherein the advertising data is located proximate to the listing data.

Still another aspect of the subject invention includes automatically rearranging segments of the second group of advertisements onto discrete electronic display pages, wherein the advertising data is located proximate to the listing data.

Yet another aspect of the subject invention includes rearranging segments of the second group of advertisements onto discrete electronic display pages, wherein the advertising data is located adjacent to the listing data.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings that form a part hereof and wherein:

FIG. 1 is a schematic representation of a computer and computer network illustrating how the computers are communicated via the network.

FIG. 2 is a schematic representation of the computer screen of FIG. 1 showing how a user may enter particular search data.

FIG. 3 is a schematic representation of the computer screen of FIG. 1 displaying particular data that has been created.

FIG. 4 is a schematic representation of a computer screen of FIG. 1 displaying additional particular data that has been created.

FIG. 5 is a schematic representation of a computer screen of FIG. 1 displaying further additional particular data that has been created.

FIG. 6 is a flow chart displaying modifications to the discrete display pages.

FIG. 7 is a flow chart displaying additional modifications to the discrete display pages.

### DESCRIPTION OF THE PREFERRED EMBODIMENT

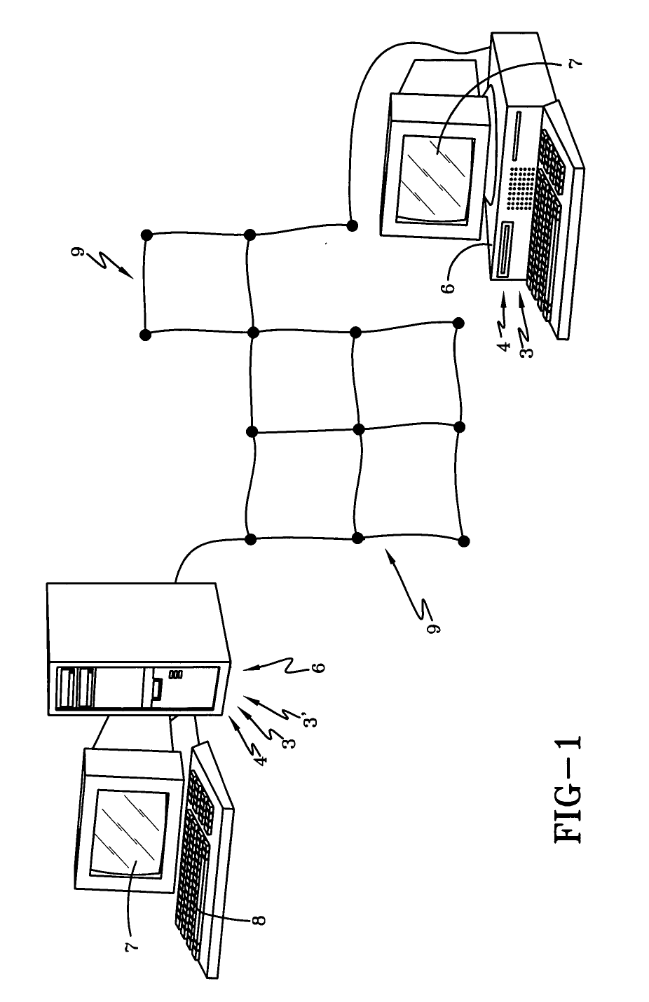

Referring now to the drawings wherein the showings are for purposes of illustrating a preferred embodiment of the invention only and not for purposes of limiting the same, FIG. 1 shows a micro-computer 3 including a motherboard 4 contained in a computer case 6. The microcomputer or computer 3 may include peripheral circuitry and components well known in the art for use in facilitating communication to a computer network 9. The computer 3 may include a screen or display 7 and keyboard 8 for use in providing input to and output from the computer 3. However, any input or output means may be used with the computer 3 as chosen with sound engineering judgment. The computer 3 may include components that transfer and receive data from the computer network 9. In this manner, the computer 3 may be operatively communicated to the computer network 9. Likewise, an associated user may have access to the computer network 9 via the computer 3 and the software loaded therein. In that the construction configuration and operation of computers 3 is well known in the art no further explanation will be offered at this time. It is also noted that other microprocessor-based devices may function in a similar manner as a computer to interface with an associated operator and be connected to a computer network, which may be a wireless network. Such devices may include but are not limited to Personal Digital Assistants (PDA), cell phones and the like. It is understood that scope of coverage for the present invention is not to be limited to a specific type of microprocessor based logic processor 3′. The computer 3 or microprocessor based logic processor 3′ as mentioned may include a screen 7 that may function to display information from the computer network 9. It is noted that in the preferred embodiment, the computer network 9 may be the Internet 9. However, any type of computer network may be utilized in conjunction with the subject invention as chosen with sound engineering judgment.

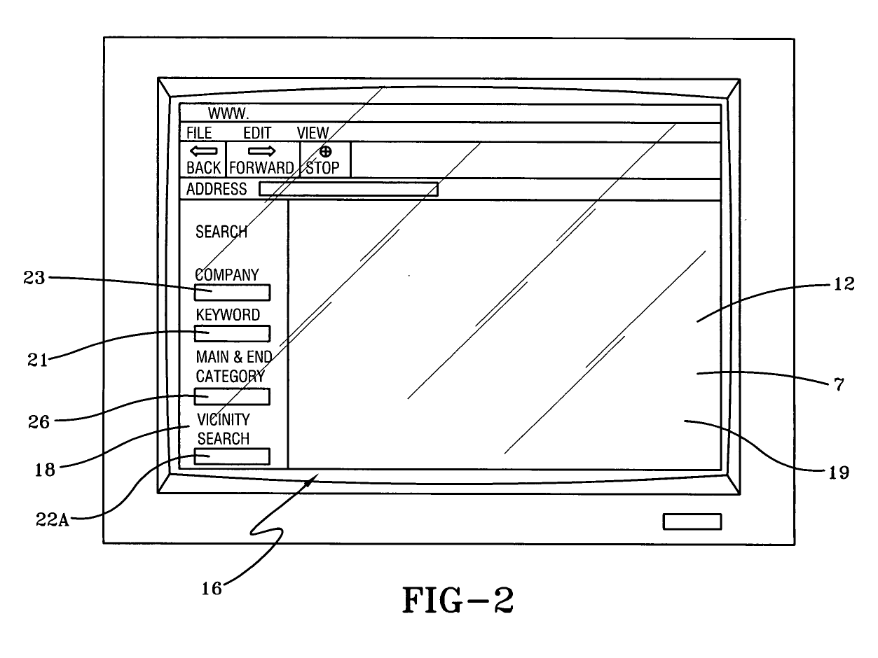

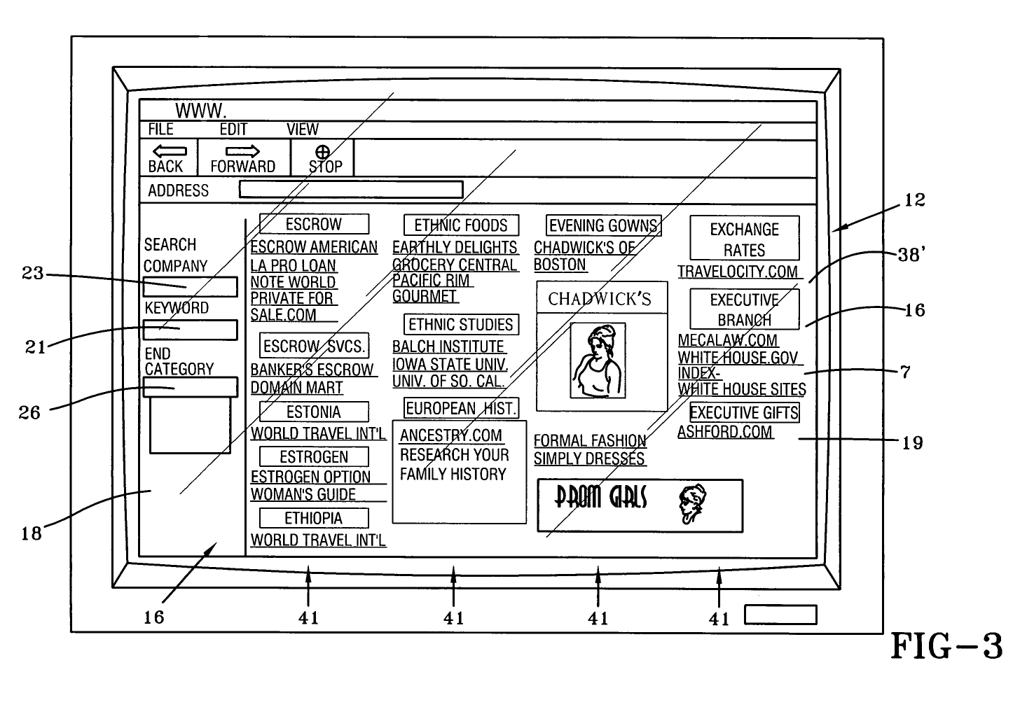

With reference now to FIGS. 2 and 3, a screen 7 is shown that may display images generated from the computer's connection to the Internet 9 or other access to the advertising search program. In one embodiment, the computer 3 may include an Internet browser 12, which may be software loaded into the memory of the computer 3. In this manner, the associated user may have visual and audio access to information transferred over the Internet. E-commerce entities may utilize the Internet for selling goods and/or services to prospective buyers. The E-commerce entities may be companies, individuals or any entity capable of transacting business. It is noted that an E-commerce entity does not necessarily have to actual sell their goods and services over the network, that is to say complete the transaction via the Internet, but may only have advertised their goods and/or services over the Internet to be considered an E-commerce entity. Continuing, the user may access the advertising search program via the computer network or Internet 9. In this way, the user may enter the web address location from which the advertising display program is executed. In one embodiment, the screen display may be generated by software that displays the two general sections of a display area 16 including a search portion 18 and a display portion 19. Any type of software may be used to generate the screen display including but not limited to HTML (Hyper-Text-Markup-Language), XML (Extended-Markup-Language) or the like. It is noted that any type of software program or language may be used with sound engineering judgment that generates a screen display and facilitates interaction with the user. Additionally, various other types of software and/or programs may interface or work in conjunction with the screen display programming such Active Server Pages or the like. It is understood that the present invention is not to be limited in scope by utilizing a specific type of programming language and/or software. Rather any programming means may be used to accomplish the functions as described herein as chosen with sound engineering judgment. In this manner, the screen 7 in conjunction with other input means functions as an interactive screen display means. That is to say that the user may receive information from and respond to the display means. Any device that functions in this manner may be construed as an interactive screen display means.

With continued reference to FIGS. 2 and 3, as mentioned, the user may access the Internet via a web-browser and the appropriate web-address gaining access to the Internet website facilitating operation of the subject invention. It is noted that the subject invention is not to be limited to Client/Server based applications and the interaction thereof over a computer network but may be utilized in an alternate embodiment as a peer-to-peer or file-server application. Still, any manner of gaining access to the advertising search program may be chosen with sound engineering judgment. Continuing, the screen 7 may display operation of the advertising search program for use by the user. The display area 16 may include a search portion 18. The search portion 18 may include a keyword search area 21 and a company search area 23 and/or the vicinity search area 22A, as generated by the aforementioned programming, in the display area 16 and more specifically in the search portion 18. Additionally, the search portion may include an end-category and main category listing region that may display in alphabetical order all of the main categories and end-categories each of which the advertisements are categorized. In this manner, a listing of main categories titles may be subsequently listed in the search portion 18. When the user clicks on the main category title, a further listing of the end-categories within that main category is displayed. The Keyword search area 21 may prompt the user to enter key words, via a keyboard or other input means, to be used in searching for a specific E-commerce entity or company. Any manner of prompting the user to enter keywords for search criteria may be chosen with sound engineering judgment. Alternately, a second search area 23, which may be a company search area 23, may be included for the user to enter in the name of a specific company name the user desires to gain contact information from. Still a third search area 26 may be included that lists the end-categories included in the program, to be discussed further in a subsequent paragraph. Another search area 22a may be included to limit the vicinity for which information of companies is being searched. It is noted that complete or partial words may be entered in the search areas 21, 23 wherein the software program would facilitate a search based upon the partial-word search criteria entered. After entering in the search criteria, the user may interact with the screen 7, via a keyboard in this case, to engage an execute command function that may begin the search. The client-side computer or other microprocessor logic processor may then, as described in the first embodiment above, communicate to the server-side computer to commence searching for a discrete display page containing the information related to the search criteria, which will be discussed further in another paragraph. The advertising data utilized by the advertising search program may be stored in a database. The search criteria entered via the interactive screen 7 and computer 3 may be communicated to the database, through any appropriate security protection, for use in searching the database against the words entered in the search area 21, 23.

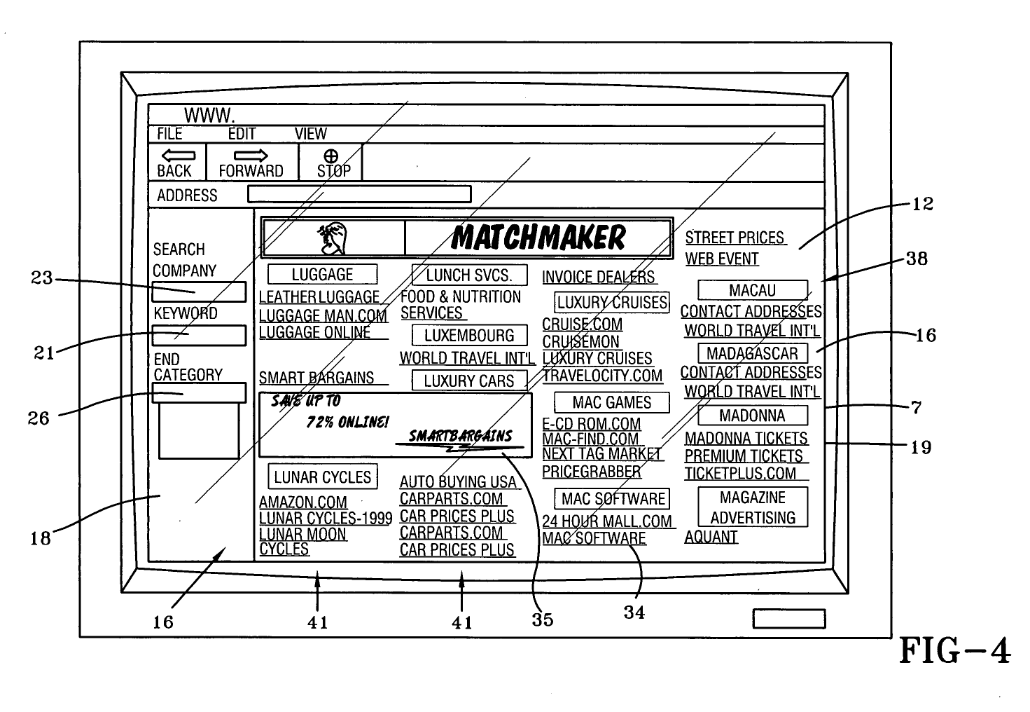

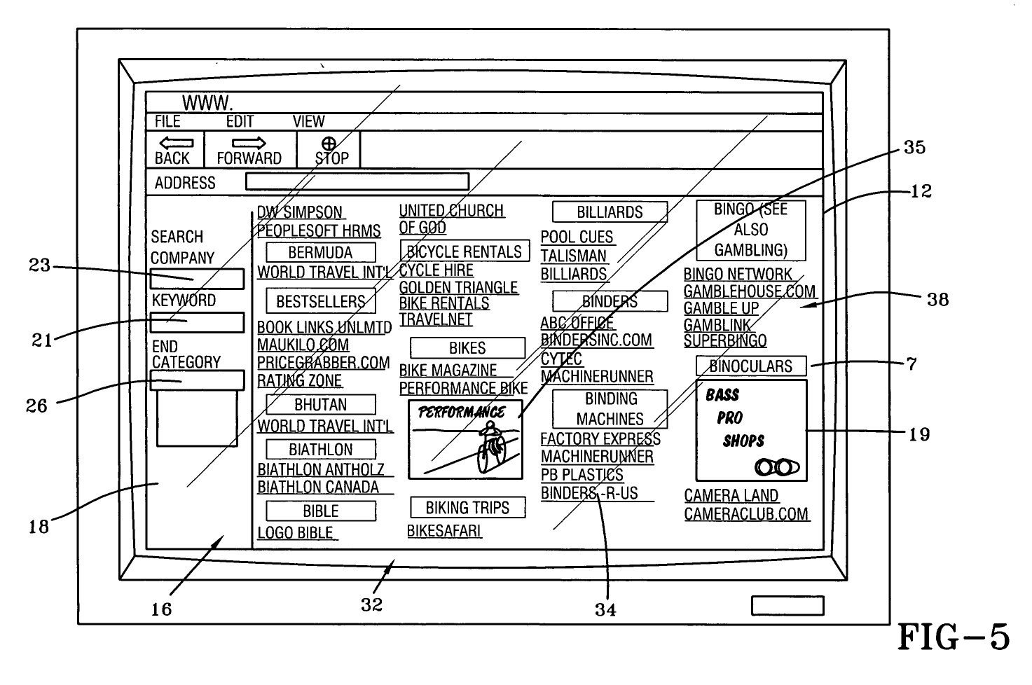

Referring now to FIGS. 3 through 5, a series of discrete display pages may be electronically created, which may include advertising information or advertisements 32 relating to the associated E-commerce entities desire to advertise with the subject invention. The advertisements 32 may be comprised of listing ads 34, banner ads 35 as well as other types of ads. A listing ad 34 may include basic contact information about a specific E-commerce entity, such as an e-mail address or street address, business description, phone number, fax number, slogan and the like. In an alternate embodiment, such basic listing ad information may only include a company name and limited contact information; such as is the case when a company has not contracted to advertise with the advertising search program. Separately, banner ad information may include a company logo with address, pictures, flashing words and the like. Such banner ads 35 may vary in size, including length and width, as desired and may further include a link to the website of that company's ad. Additionally, the banner may include a picture of the company or any other type of information chosen with sound judgment. Any type and configuration of ad displayed may be chosen with sound engineering judgment that is suitable for a banner ad display. The information contained in the ads may be stored in the database as previously mentioned but may be formatted into a different configuration when displayed in the display area 16. Still, the information in the database and ads may correspond directly. That is to say that the database information may be linked to the ad in which the database information is depicted. It is noted that when an advertiser signs up to advertise via the advertising search program, information about the advertiser and the advertiser's advertisements may be initially received and entered into the database for use in setting up the advertiser as an advertiser in the system.

With continued reference to FIGS. 3 through 5, the advertisements 32 may be electronically prearranged onto an individual electronic display page 38. By electronically it is meant that, in this case, advertisements may be created or converted into a form that can be stored, configured or manipulated via electronic or software means. This may include pictures, video clips, graphics, font type, characters, etc. Therefore, by electronically prearranged it is meant that the advertising information is saved and/or stored via software and may be inserted into a program for display as desired. Any type of graphics or other program algorithm may be used to configure the depicted ads as chosen with sound engineering judgment. Additionally, an electronic display page may therefore include a computer image that is electronically, e.g. software means, generated and displayed on the screen 7. Such digital information may be selectively loaded into computer memory, as is well known in the art, for use in displaying the electronic display page as will be discussed further in a subsequent paragraph. The electronic display pager or discrete display page 38 therefore may be programmed by way of any software program chosen with sound engineering judgment, wherein the discrete display page 38 can be searched, selected and displayed electronically on the screen 7.

With continued reference to FIGS. 3 through 5, in one embodiment, the discrete display page 38 may include four (4) columns 41 having a non-variable width. However, it is understood that the subject invention is not limited to four (4) columns. Any columnar format including two (2) or more columns may be chosen with sound judgment as is appropriate for use with the subject invention. The width of the columns may be formatted to fit the display area as desired. However, any display column width may be chosen with sound engineering judgment. The width may be measured in pixels or in inches/centimeters as is appropriate for use with the subject invention. As mentioned before, the size of the advertisements 32 may vary in size. In one embodiment, only the length of the advertisement may vary in size, wherein the width is fixed with regard to sellable ad space. That is to say that one E-commerce entity may, for example, desire to utilize 2 inches (in length) of column space and another E-commerce entity may desire to utilize 3 inches of column space. Therefore the configuration of a discrete display page depends upon the size or length of the ads placed in the columns. By discrete it is meant that a display page is not generated and displayed as an ongoing list of information, but rather is statically prearranged for display on the screen 7. That is to say that the discrete display page 38, containing the ads, does not change with differing search criteria, but may only change when new advertisers and advertisements are added to the system. This is uniquely different from the myriad of search engines that simply display single columnar lists of information returned from a search engine. However, it is noted that any number of columns may be incorporated into the discrete display pages 38 as is chosen with sound engineering judgment.

With continued reference to FIGS. 3 through 5, the various types of advertisements 32, namely listing ads 34, banner ads 35 and the like, may be placed in order and in columnar format on one or more discrete display pages 38. In one embodiment, the listing ads 34 may all be the same length and may be alphabetically listed in the columns. It is noted that the listing ads 34 are completely contained within a single column. Banner ads 35 or other type ads may be interspersed in between the listing ads and may span one or more columns. The discrete display pages 38 may also be fixed in size. That is to say that the information depicted on the display page does not automatically change responsive to the search criteria enter in the search area. In this manner, one exemplary discrete display page 38 may display a section of the database corresponding to listing ads 34 beginning in the upper left hand corner and leftward column and proceeding alphabetically down each column from left to right ending in the bottom right corner of the right-most column. Banner ads 35, having variable length or width, may be positioned adjacent to the listing ads; such as in an adjacent column. It is noted that a banner ad 35, corresponding to a specific listing ad 34, may be located on the previous discrete page still being proximate to the corresponding listing ad 34 immediately following on the next consecutive discrete page. In this manner, it is understood that the banner ad 35 may be positioned directly on the previous or subsequent page with respect to the position of the listing ad 34. Of course, banner ads 35 displayed in an adjacent column may span several listing ads 35 in that the banner ad 35 may be equal in length and width to several listing ads 34. It may be desirable to display the larger, more visible banner ads 35 close to the listing ad 34 to maximize exposure to potential customers searching for a particular. It may also be desirable to optimize the amount of ad information on a single discrete display page 38 to maximize the overall advertising exposure to potential customers. Therefore, placement of the various ads is important when statically constructing a particular discrete display page 38. It is noted that prior and subsequent display pages 38 may be sequential continuations of the alphabetical listing ads. That is to say that within a single end-category the corresponding ads may all be contained on sequential pages overrunning from one discrete display page 38 to the next.

With continued reference to FIG. 3 through 5, any given E-commerce entity may produce or offer multiple goods and services. In this manner, the E-commerce entity may chose to advertise in multiple end-categories. An ad, banner 35 or otherwise, may link to different departments or websites, within the E-commerce entity's company. When new E-commerce entities are added to the list of advertisers with the advertising search program or when new end-category ads are listed from an existing E-commerce entity, new listing ads 34 and/or banner ads 35 may be added to the database of information. The E-commerce entity may also select multiple words whereby the E-commerce entity's product may be identified. That is to say that entering a new ad may be accompanied by selecting keywords by which the ads may be located during a search. Any manner of selecting and implementing keywords for use in identifying ads, banner, listing or otherwise, may be chosen with sound business or engineering judgment. Hence, it may be required that the discrete display pages 38 be altered to include new the ads 34, 35. When new ads, listing 34 and banner 35, are added to the discrete display pages 38, a software program may optimize the position of the listing 34 and banner 35 ads on each of the discrete display pages 38. The software program may calculate the number listing ads 34 having associated banner ads 35 and may place the banner ads within close proximity to the associated listing ad 34. Additionally, listing ads 34 may continue to be alphabetically listed until a particular display page 38 is filled up. In this way, the discrete display page is optimally configured to utilize the display page space and to position the associated banner ads close to the listing ads. It is noted that any software means may be used to optimally configure the discrete display pages 38. It is noted that when new ads 34, 35 are inserted into the existing discrete display pages 38, each subsequent page 38′ may be reconfigured and optimized to display the remaining ads 34, 35. In this manner, the discrete display pages 38 may be dynamically modified, but are statically displayed within the searching process.

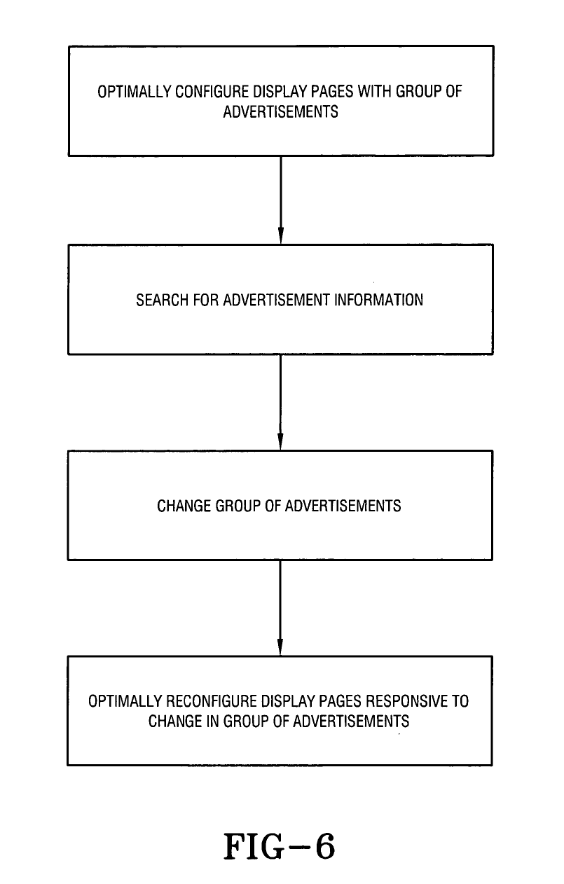

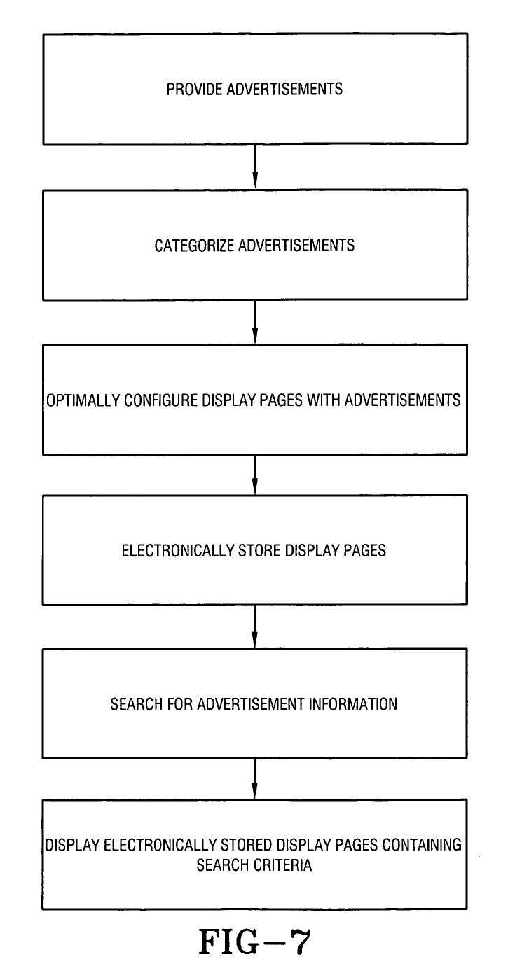

With reference to all of the FIGURES, but especially to FIGS. 6 and 7, the operation of the subject invention will now be discussed. Advertisements are provided for display in the advertising search program. Programming means are provided that account for the size of listing ads and banner ads advertising one or more of E-commerce entity's goods and services. Discrete display pages may be created with multiple columns filled by listing ads and banner ads. The programming means optimally configures individual discrete display pages with the listing ads and banner ads, which may be shown on a screen 7 and communicated over the Internet. The banner ads are positioned proximate to the listing ads. With the discrete display configured, an interactive search area may be generated and communicated by a server computer and displayed on a remote screen over the Internet. The interactive search area may be communicated to the optimally configured discrete display pages. When as associated user of the advertising search program enters search criteria into the interactive search area, the advertising search program searches for the discrete display page(s) that contain advertisements related to the search criteria. The page that contains the related advertising information is then display on the remote screen, wherein the associated user may view and continue to interact with the screen to select the desired advertisement. The associated user may depress a mouse button that may engage a link to the website or other information of a particular ad. It is noted that the discrete display pages are sequenced and the user may cycle through the discrete display pages to look for other advertisements. In this way, the listing ads may be alphabetically listed with end-categories, of which the end-categories may be alphabetically listed on the plurality of discrete display pages.

With continued reference to all of the FIGURES, and especially to FIGS. 6 and 7, a new listing ad and/or banner ad may be added to the advertising search program. The data from the new E-commerce entity ad may be added to the database of information and a new graphic (banner ad) or listing may be created for insertion into the appropriate end-category. Programming means may then manipulate the discrete display space to include the new graphic or listing ad; displacing existing ads, both listing and banner ads, to other areas and possibly alternate discrete display pages. The advertising search program may be subsequently updated with the newly modified discrete display page configurations.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

I/we claim:

1. A method of displaying advertising data for E-commerce entities, the steps comprising:
providing advertising information for a plurality of advertising entities, the advertising information comprising one or more advertisements;
providing a microprocessor-based logic processor for use in electronically storing the advertising information;
arranging at least a first discrete electronic display page of at least a first portion of the advertising information in a multi-columnar format;
providing an electronic searching means operatively communicated to access the advertising information for use in selectively identifying at least one advertisement;
selectively searching for at least one advertisement; and,
displaying the at least a first discrete electronic display page containing the selectively searched at least one advertisement.

2. The method of claim 1, further comprising the step of:
providing an electronic displaying means for use in displaying electronic data, the electronic displaying means being operatively communicated to the microprocessor-based logic processor; and,
wherein the step of, displaying the at least a first discrete electronic display page containing the selectively searched at least one advertisement, comprises the step of:
displaying the at least a first discrete electronic display page containing the selectively searched at least one advertisement on the electronic displaying means.

3. The method of claim 2, wherein before the step of displaying the discrete electronic display page on the electronic displaying means, the method comprises the step of:
electronically receiving the selectively identified discrete electronic display page containing the at least one of the plurality of individual advertisements.

4. The method of claim 3, wherein the step of providing an electronic searching means operatively communicated to access the advertising information for use in selectively identifying at least one advertisement, comprises the step of:
providing an electronic searching means communicated through an associated computer network to access the advertising information for use in selectively identifying at least one advertisement.

5. The method of claim 4, wherein the step of providing advertising information for a plurality of advertising entities, the advertising information comprising one or more advertisements, comprises the step of:
providing advertising information for a plurality of advertising entities, the advertising information comprising one or more advertisements, wherein the advertisements comprise listing ads and, banner ads, wherein the banner ads correspond to the listing ads.

6. The method of claim 5, wherein the step of providing a microprocessor-based logic processor for use in electronically storing the advertising information, comprises the step of:
providing a computer server operatively connected to the Internet for use in electronically storing the advertising information.

7. The method of claim 6, wherein the step of arranging at least a first discrete electronic display page of at least a first portion of the advertising information in a multi-columnar format, comprises the step of:
arranging at least a first discrete electronic display page of at least a first portion of the advertising information in a multi-columnar format, wherein the corresponding banner ads are positioned proximate to the listing ads.

8. A method of displaying advertising data for E-commerce entities, the steps comprising:
providing an interactive electronic display screen having a first search section and a second display section;
providing one or more associated E-commerce entities having at least one of advertising data and listing data;
storing the advertising data and listing data;
prearranging segments of the advertising data and listing data onto individual electronic display pages;
providing a communication link between the interactive electronic display screen and the advertising data and listing data;
selectively searching for a specific item of advertising data or listing data in the first search section;
retrieving the electronic display page having said specific item of data; and,
displaying the electronic display page in the second display section.

9. The method of claim 8, wherein the step of providing an interactive electronic display screen, further comprises the step of:
providing a microprocessor based interactive electronic display screen having a first search section and a second display section.

10. The method of claim 9, wherein the step of providing a microprocessor based interactive electronic display screen having a first search section and a second display section, further comprises the step of:
providing a micro-computer having a display screen exhibiting a first search section and a second display section.

11. The method of claim 9, wherein the step of providing a microprocessor based interactive electronic display screen having a first search section and a second display section, further comprises the step of:
providing a portable microprocessor based interactive electronic display screen having a first search section and a second display section.

12. The method of claim 9, wherein the step of providing one or more E-commerce entities having associated advertising data and associated listing data respectively, comprises the step of:
providing one or more E-commerce entities having associated advertising data and associated listing data respectively, wherein the display size of the associated advertising data and associated listing data varies from one E-commerce entity to the next.

13. The method of claim 9, wherein the step of prearranging segments of the advertising data and listing data onto individual electronic display pages, comprises the step of:
statically prearranging segments of the advertising data and listing data onto individual electronic display pages, wherein the advertising data and listing data is optimally arranged into multiple columns.

14. The method of claim 8, wherein before the step of prearranging segments of the advertising data and listing data onto individual electronic display pages, the method comprises the step of:
electronically sorting the advertising data and listing data into a plurality of end-categories.

15. The method of claim 14, wherein after the step of electronically sorting the advertising data and listing data into a plurality of end-categories, the method comprises the step of:
electronically sorting the advertising data and listing data alphabetically.

16. A method of advertising data for E-commerce entities, the steps comprising:
providing a first group of one or more advertisements for a first group of associated E-commerce entities, the advertisements comprising: advertising data and listing data;
electronically storing the first group of advertisements on a computer server;
prearranging segments of the first group of one or more advertisements onto discrete electronic display pages;
providing an interactive searching means for use in searching one or both of advertising data and listing data, the interactive searching means being operatively communicated to the computer server;
adding advertisements to the first group of one or more advertisements thereby comprising a second group of advertisements; and,
rearranging segments of the second group of advertisements onto discrete electronic display pages.

17. The method of claim 16, wherein the step of prearranging segments of the first group of one or more advertisements onto discrete electronic display pages, comprises the step of:
prearranging segments of the first group of one or more advertisements onto discrete electronic display pages, wherein the advertising data is located proximate to the listing data.

18. The method of claim 17, wherein the step of rearranging segments of the second group of advertisements onto discrete electronic display pages, comprises the step of:
rearranging segments of the second group of advertisements onto discrete electronic display pages, wherein the advertising data is located proximate to the listing data.

19. The method of claim 18, wherein the step of rearranging segments of the second group of advertisements onto discrete electronic display pages, wherein the advertising data is located proximate to the listing data, comprises the step of:
automatically rearranging segments of the second group of advertisements onto discrete electronic display pages, wherein the advertising data is located proximate to the listing data.

20. The method of claim 19, wherein the step of rearranging segments of the second group of advertisements onto discrete electronic display pages, wherein the advertising data is located proximate to the listing data, comprises the step of:
rearranging segments of the second group of advertisements onto discrete electronic display pages, wherein the advertising data is located adjacent to the listing data.
